(19) United States
(12) Patent Application Publication
(10) Pub. No.: US 2026/0326756 A1
(43) Pub. Date: Oct. 22, 2026

(54) ADAPTIVE VEHICLE STEERING OVERRIDE FOR PATH FOLLOWING LANE CHANGES

(71) Applicant: GM GLOBAL TECHNOLOGY OPERATIONS LLC, Detroit, MI (US)

(72) Inventors: Milad JALALIYAZDI, Richmond Hill (CA); Kin Man Michael Wong, Thornhill (CA); Reza Zarringhalam, Whitby (CA); Alexander Gene Rath, Fenton, MI (US)

(21) Appl. No.: 19/186,234

(22) Filed: Apr. 22, 2025

(51) Int. Cl. B60W 30/12; B60W 10/04; B60W 10/18; B60W 10/20; B60W 30/095; B60W 50/10; G06V 20/56; G06V 20/58; B62D 6/00; B62D 15/02

(52) U.S. Cl. CPC B60W 30/12; B60W 10/04; B60W 10/18; B60W 10/20; B60W 30/0956; B60W 50/10; G06V 20/58; G06V 20/588; B60W 2420/403; B60W 2510/202; B60W 2540/20; B60W 2552/10; B60W 2554/4041; B60W 2710/18; B60W 2710/202; B60W 2720/106; B62D 6/00; B62D 15/025

(57) ABSTRACT

An example steering control system for a vehicle includes a front vehicle camera configured to capture images including lane boundaries of a road lane of the vehicle, a steering wheel configured to control a steering orientation of front wheels of the vehicle, and a torque sensor configured to detect a torque value applied to the steering wheel. A vehicle control module is configured to control automatic lane center assist steering according to images captured by the front vehicle camera, receive a turn signal input, change a steering torque override threshold from a first value to a second value in response to receiving the turn signal input, where the second value is less than the first value, and in response to detecting a torque value from the torque sensor greater than the second value, deactivate automatic lane center assist steering to facilitate a manual lane change via steering wheel input.

### INTRODUCTION

The information provided in this section is for the purpose of generally presenting the context of the disclosure. Work of the presently named inventors, to the extent it is described in this section, as well as aspects of the description that may not otherwise qualify as prior art at the time of filing, are neither expressly nor impliedly admitted as prior art against the present disclosure.

The present disclosure relates to adaptive vehicle steering override for path following lane changes.

Vehicles are equipped with steering mechanisms including a steering wheel configured to control a steering orientation of the vehicle. A hands-on lane centering assist (HoLCA) system uses one or more cameras or additional sensing to automatically control steering of the vehicle in an attempt to maintain a position of the vehicle near a center of a road lane.

### SUMMARY

An example steering control system for a vehicle includes a front vehicle camera configured to capture images including lane boundaries of a road lane of the vehicle, a steering wheel configured to control a steering orientation of front wheels of the vehicle, a torque sensor configured to detect a torque value applied to the steering wheel, and a vehicle control module configured to control automatic lane center assist steering of the vehicle according to images captured by the front vehicle camera, receive a turn signal input, change a steering torque override threshold from a first value to a second value in response to receiving the turn signal input, where the second value is less than the first value, and in response to detecting a torque value from the torque sensor greater than the second value, deactivate automatic lane center assist steering to facilitate a manual lane change via steering wheel input.

In some examples, the steering torque override threshold is greater at a first position adjacent to one of the lane boundaries than at a second position adjacent a center of the road lane.

In some examples, the vehicle control module is configured to determine a left direction or a right direction of the turn signal input, and change the steering torque override threshold from the first value to the second value only in the left direction or the right direction corresponding to the turn signal input.

In some examples, the steering control system includes at least one of a side vehicle camera and a rear vehicle camera, wherein the vehicle control module is configured to identify another vehicle threat in an adjacent lane in the left direction or the right direction corresponding to the turn signal input, based on one or more images captured by the at least one of the side vehicle camera and the rear vehicle camera, and maintain the steering torque override threshold at the first value during a period of identifying another vehicle threat in the adjacent lane.

In some examples, the second value is at least 0.5 Newton-meters less the first value. In some examples, the second value is less than or equal to two Newton-meters.

In some examples, the vehicle control module is configured to determine whether a driver is contacting the steering wheel via one or more touch sensors, and maintain the steering torque override threshold at the first value during a period of identifying that the driver of the vehicle is not contacting the steering wheel.

In some examples, the vehicle control module is configured to access a navigation route for the vehicle, and automatically control steering, acceleration and braking of the vehicle to cause the vehicle to follow the navigation route.

In some examples, the vehicle control module is configured to identify a manual turn request location along the navigation route, and in response to determining that a distance between a vehicle location and the manual turn request location is less than a manual turn distance threshold, change the steering torque override threshold from the first value to the second value.

In some examples, the vehicle control module is configured to receive the turn signal input via movement of a turn signal lever of the vehicle.

An example steering control system for a vehicle includes a front vehicle camera configured to capture images including lane boundaries of a road lane of the vehicle, a steering wheel configured to control a steering orientation of front wheels of the vehicle, a torque sensor configured to detect a torque value applied to the steering wheel, and a vehicle control module configured to access a navigation route for the vehicle, control automatic lane center assist steering of the vehicle according to images captured by the front vehicle camera, to cause the vehicle to follow the navigation route, identify a manual turn request location along the navigation route, in response to determining that a distance between a vehicle location and the manual turn request location is less than a manual turn distance threshold, change a steering torque override threshold from a first value to a second value, where the second value is less than the first value, and in response to detecting a torque value from the torque sensor greater than the second value, deactivate automatic lane center assist steering to facilitate a manual lane change via steering wheel input.

In some examples, the steering torque override threshold is greater at a first position adjacent to one of the lane boundaries than at a second position adjacent a center of the road lane.

In some examples, the vehicle control module is configured to determine a left direction or a right direction of the manual turn request location, and change the steering torque override threshold from the first value to the second value only in the left direction or the right direction corresponding to the manual turn request location.

In some examples, the steering control system includes at least one of a side vehicle camera and a rear vehicle camera, wherein the vehicle control module is configured to identify another vehicle threat in an adjacent lane in the left direction or the right direction corresponding to the manual turn request location, based on one or more images captured by the at least one of the side vehicle camera and the rear vehicle camera, and maintain the steering torque override threshold at the first value during a period of identifying another vehicle threat in the adjacent lane.

In some examples, the second value is at least 0.5 Newton-meters less the first value. In some examples, the second value is less than or equal to two Newton-meters.

In some examples, the vehicle control module is configured to determine whether a driver is contacting the steering wheel via one or more touch sensors, and maintain the steering torque override threshold at the first value during a period of identifying that the driver of the vehicle is not contacting the steering wheel.

An example method of steering control in a vehicle includes controlling, by a vehicle control module, automatic lane center assist steering of a vehicle according to images captured by a front vehicle camera, wherein the front vehicle camera is configured to capture images including lane boundaries of a road lane of the vehicle, receiving a turn signal input, changing a steering torque override threshold from a first value to a second value in response to receiving the turn signal input, where the second value is less than the first value, receiving, from a torque sensor, a torque value applied to a steering wheel of the vehicle, and in response to the torque value being greater than the second value, deactivating automatic lane center assist steering to facilitate a manual lane change via steering wheel input.

In some examples, the method includes accessing a navigation route for the vehicle, and automatically controlling steering, acceleration and braking of the vehicle to cause the vehicle to follow the navigation route.

In some examples, the method includes identifying a manual turn request location along the navigation route, and in response to determining that a distance between a vehicle location and the manual turn request location is less than a manual turn distance threshold, changing the steering torque override threshold from the first value to the second value.

Further areas of applicability of the present disclosure will become apparent from the detailed description, the claims and the drawings. The detailed description and specific examples are intended for purposes of illustration only and are not intended to limit the scope of the disclosure.

### BRIEF DESCRIPTION OF THE DRAWINGS

The present disclosure will become more fully understood from the detailed description and the accompanying drawings, wherein:

FIG. 1 is a diagram of an example vehicle including a vehicle control module configured to provide steering control in a hands-on lane centering assist (HoLCA) system, according to the present disclosure;

FIG. 2A is a top view diagram of an example vehicle executing a steering turn on a road for a lane change, according to the present disclosure;

FIG. 2B is a line graph illustrating example steering wheel torque thresholds for overriding hands-on lane centering assist control, according to the present disclosure;

FIG. 3 is a flowchart depicting an example process for adjusting an override threshold in response to a turn signal, according to the present disclosure;

FIGS. 4A-4C are top view diagrams of a vehicle executing a lane change with a reduced torque override threshold in response to a turn signal, according to the present disclosure;

FIGS. 5A-5C are top view diagrams of a vehicle executing a lane change with a detected side threat, according to the present disclosure;

FIG. 6 is a flowchart depicting an example process for adjusting an override threshold in response to a manual lane change request along a navigation route, according to the present disclosure; and

FIGS. 7A-7C are top view diagrams of a vehicle executing a lane change with a reduced torque override threshold in response to a manual lane change request, according to the present disclosure.

In the drawings, reference numbers may be reused to identify similar and/or identical elements.

### DETAILED DESCRIPTION

Some example embodiments described herein relate to lane center assist (LCA) steering control, such as hands-on lane center assist (HoLCA), which automatically controls steering of the vehicle in an attempt to maintain a location of the vehicle near a center of a road lane (e.g., based on detection of lane boundaries by one or more front vehicle cameras or other sensors). When a manual lane change is requested by either the system or the driver (such as while the vehicle is following a navigation route), the driver may be expected to manually execute the lane changes. This may occur during various driving conditions, such as when one or more vehicle perception sensors are unavailable (e.g., driving on unmapped roads), when the vehicle is driving at speeds below a minimum speed needed for automatic lane changes, or when the system cannot take the correct side of a road split. In these circumstances, a vehicle control module may request the driver to manually make a lane change while the vehicle control module continues to maintain lane centering.

In some examples, a torsion bar torque threshold is established, such that the vehicle control module continues to maintain lane centering assist steering control even if the steering wheel is rotated slightly, until an amount of torque applied to the steering wheel exceeds the threshold. This may avoid accidental or unintended deactivations of the lane centering assist in response to minor contacts with the steering wheel, while still allowing a driver to manually take over steering control by applying more torque above a threshold amount.

The vehicle control module may be configured to lower the override torque threshold in response to a requested manual lane change from a route navigation system, or when a driver indicates an upcoming lane change (such as by activating a turn signal). For example, if the manual lane change request or turn signal input suggests that a manual lane change may be happening soon, lowering the override torque threshold allows for a smoother transition from the lane centering assist control to the manual lane change maneuver (e.g., due to less steering wheel torque required to deactivate the automatic lane centering assist control).

The override torque threshold may not be lowered in some driving situations, such as detection of a side threat vehicle in the adjacent lane, or a driver not having their hands on the steering wheel. This may protect the driver from accidentally deactivating the lane centering assist control due to the lowered threshold, to avoid stopping the lane centering assist control unless a normal threshold of torque is applied to the steering wheel (which would more likely indicate that the driver intends to manually change lanes even in view of the detected side threat vehicle).

As another example safety feature, in various implementations the override torque threshold may only be lowered in a direction of the impending lane change. For example, if a right turn signal is indicated, the override torque threshold may be lowered for manual turning of the steering wheel to the right, while maintaining a normal or default override torque threshold when the steering wheel is turned to the left.

Some example embodiments may provide one or more benefits or advantages, such as maintaining lane centering assist control before and until a driver is ready to make a manual lane change, resolving a “fighting” feeling between a driver and the vehicle control module that may occur if the vehicle control module rigidly continues lane centering assist control, and allowing for smoother steering feel while transitioning from lane centering assist control to manual lane changes. Example vehicle control modules may prevent or inhibit accidental overrides on an opposite side of the indicated manual lane change, by leaving override torque thresholds the same on the opposite, helping to inform the vehicle control module about imminent driver overrides in the lane change direction, and ensuring or facilitating maintenance of higher (e.g., default or normal) override torque thresholds in the event that a side vehicle threat is present in the intended change direction.

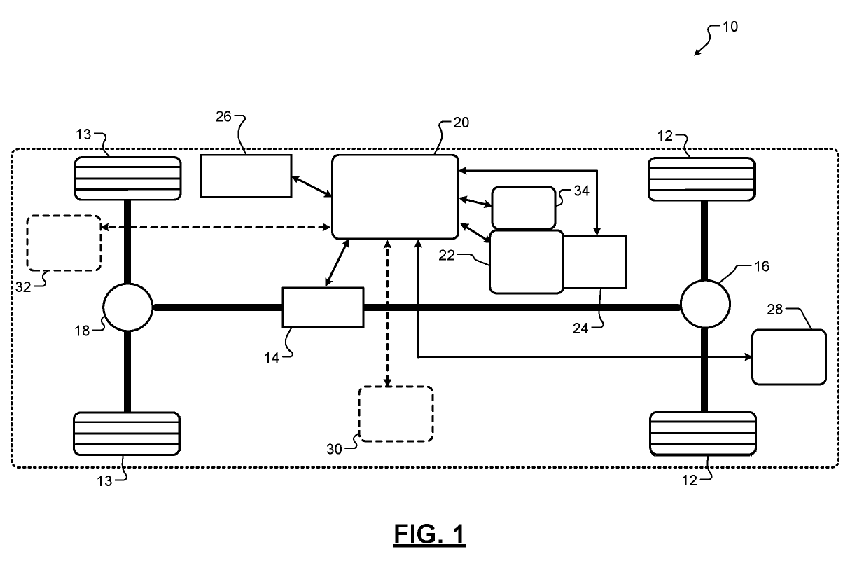

Referring now to FIG. 1, a vehicle 10 includes front wheels 12 and rear wheels 13. In FIG. 1, a drive unit 14 selectively outputs torque to the front wheels 12 and/or the rear wheels 13 via drive lines 16, 18, respectively. The vehicle 10 may include different types of drive units. For example, the vehicle may be an electric vehicle such as a battery electric vehicle (BEV), a hybrid vehicle, or a fuel cell vehicle, a vehicle including an internal combustion engine (ICE), or other type of vehicle.

Some examples of the drive unit 14 may include any suitable electric motor, a power inverter, and a motor controller configured to control power switches within the power inverter to adjust the motor speed and torque during propulsion and/or regeneration. A battery system provides power to or receives power from the electric motor of the drive unit 14 via the power inverter during propulsion or regeneration.

While the vehicle 10 includes one drive unit 14 in FIG. 1, the vehicle 10 may have other configurations. For example, two separate drive units may drive the front wheels 12 and the rear wheels 13, one or more individual drive units may drive individual wheels, etc. As can be appreciated, other vehicle configurations and/or drive units can be used.

The vehicle control module 20 may be configured to control operation of one or more vehicle components, such as the drive unit 14 (e.g., by commanding torque settings of an electric motor of the drive unit 14). The vehicle control module 20 may receive inputs for controlling components of the vehicle, such as signals received from a steering wheel 22, an acceleration pedal, a brake pedal, a wheel position sensor, a torque sensor 24 connected to the steering wheel 22, an inertia measurement unit (IMU), a turn signal input 34 (such as a turn signal lever adjacent the steering wheel 22), etc. The vehicle control module 20 may monitor telematics of the vehicle for safety purposes, such as vehicle speed, vehicle location, vehicle braking and acceleration, etc.

The vehicle control module 20 may receive signals from any suitable components for monitoring one or more aspects of the vehicle, including one or more vehicle sensors (such as steering linkage torque sensors, cameras, microphones, pressure sensors, steering wheel position sensors, braking sensors, location sensors such as global positioning system (GPS) antennas, wheel height and/or position sensors, accelerometers, etc.). Some sensors may be configured to monitor current motion of the vehicle, acceleration of the vehicle, braking of the vehicle, current steering direction of the vehicle, current net torque applied to a steering linkage (e.g., a torsion bar) of the vehicle, current lateral acceleration of the vehicle, current yaw rate of the vehicle, current steering wheel position and angle, current road wheel position and angle, turn signal inputs, etc.

As shown in FIG. 1, the vehicle 10 includes a front vehicle camera 28, configured to capture images of a field of view in front of the vehicle 10. The field of view may be a wide field of view (such as a least a thirty degree field of view, a forty-five degree field of view, a sixty degree field of view, a ninety degree field of view, etc.), in order to capture objects on sides of a road on which the vehicle 10 is traveling, lane boundaries of a current road lane the vehicle 10 is traveling in, etc.

The vehicle 10 may include an optional rear vehicle camera 32, which may be configured to capture images in a field of view from a rear of the vehicle 10. For example, the optional rear vehicle camera 32 may capture images of a target rear vehicle following the vehicle 10, to determine whether a rear vehicle is close enough in an adjacent lane to present a possible side vehicle threat for manual lane changes of the vehicle 10.

As shown in FIG. 1, the vehicle 10 includes an optional side vehicle camera 30, which may capture images of a target vehicle to the side of the vehicle 10, to determine whether the side vehicle is close enough in an adjacent lane to present a possible side vehicle threat for manual lane changes of the vehicle 10. In various implementations, the vehicle 10 may include more or less of any of these optional vehicle cameras. The vehicle 10 may include any suitable laser, lidar sensor, radar, etc., which is used to detect objects around the vehicle 10.

In some example embodiments, a vehicle object detector may be configured to detect a closest in-path vehicle (CIPV) (e.g., another vehicle in front of a current driving path of the vehicle 10), a vulnerable road user (VRU) (e.g., a pedestrian or cyclist), current road lane boundaries, etc. The vehicle control module 20 may be configured to control movement of the vehicle 10 based on a detected CIP target vehicle, detected side vehicle threats, current road lane boundaries and an estimated center of the road lane, etc., such as by increasing or decreasing automated acceleration of the vehicle 10 (e.g., by controlling power or torque output by a motor), automatically applying brakes of the vehicle 10 (such as in response to a crash imminent braking event), adjusting an automated steering mechanism of the vehicle 10 to execute a lane change maneuver or attempt to maintain a location of the vehicle 10 in a center of the lane between the lane boundaries, etc.

The vehicle 10 includes a steering wheel 22, which is configured to control a steering orientation of the front wheels 12 based on driver input, such as rotating the steering wheel 22. As mentioned above, a torque sensor 24 may be configured to sense an amount of torque applied to the steering wheel or steering linkage (such as by the driver rotating the steering wheel 22). A turn signal input 34 may be located adjacent the steering wheel 22, such as a turn signal lever than may be moved up or down to indicate a left or right turn, a turn signal button or paddles, etc.

The vehicle control module 20 may communicate with another device via a wireless communication interface 26, which may include one or more wireless antennas for transmitting and/or receiving wireless communication signals. For example, the wireless communication interface 26 may communicate via any suitable wireless communication protocols, including but not limited to vehicle-to-everything (V2X) communication, Wi-Fi communication, wireless area network (WAN) communication, cellular communication, personal area network (PAN) communication, short-range wireless communication (e.g., Bluetooth), etc. The wireless communication interface 26 may communicate with a remote computing device over one or more wireless and/or wired networks. Regarding the vehicle-to-vehicle (V2X) communication, the vehicle 10 may include one or more V2X transceivers (e.g., V2X signal transmission and/or reception antennas).

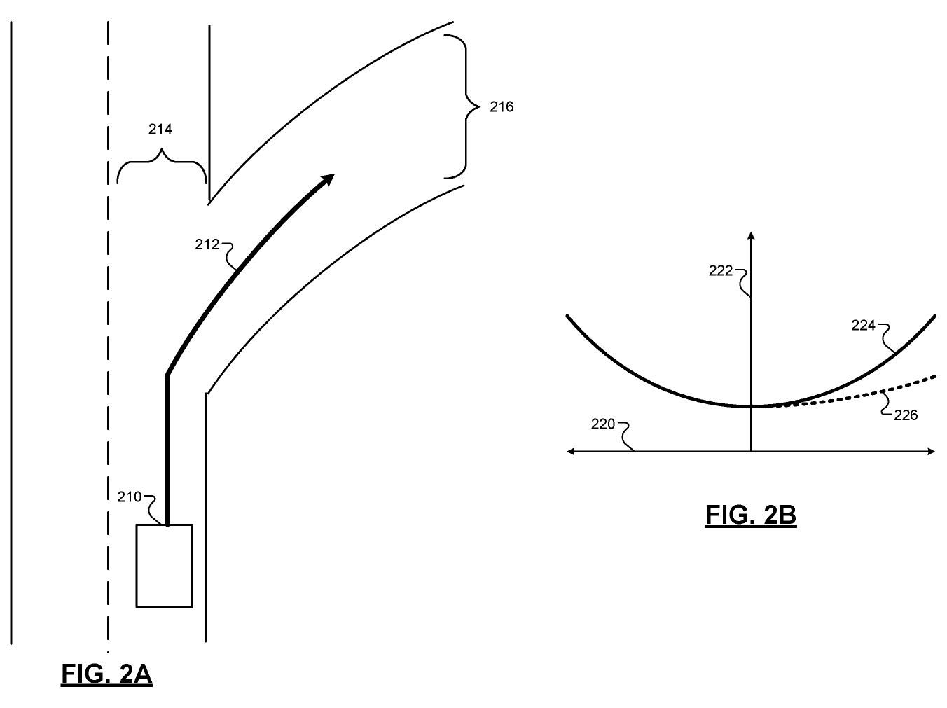

FIG. 2A is a top view diagram of a vehicle 210 executing a steering turn on a road for a lane change. As shown in FIG. 2A, lane boundaries define a current road lane 214 that the vehicle 210 is traveling in. A manual lane change 212 may be executed to change to another lane other than the current road lane 214, such as turning into a target lane 216.

In some examples, a vehicle control module may implement hands-on lane centering assist control (HoLCA) to attempt to maintain a location of the vehicle 210 near a center of the current road lane 214, such as by adjusting steering of the vehicle automatically based on images of the boundaries of the current road lane 214 as captured by a front vehicle camera.

The vehicle control module may use an override torque threshold to determine when to deactivate the HoLCA control, to allow steering control by a driver to manually execute a lane change maneuver. For example, the vehicle control module may continue to implement HoLCA control in response to minor movements of the steering wheel, but deactivate HoLCA control in response to the driver applying a sufficient amount of torque to the steering wheel to overcome the override torque threshold.

FIG. 2B is a line graph illustrating example steering wheel torque thresholds for overriding hands-on lane centering assist control. As shown in FIG. 2B, the override torque threshold value 222 may change based on a distance 220 of the vehicle 210 from a center of the current road lane 214.

For example, the override torque threshold value 222 may be lower when the vehicle 210 is near the center of the current road lane 214, and higher when the vehicle 210 is near a boundary of the current road lane (e.g., a painted solid or dotted line on the road which indicates an edge of the lane). This allows the driver to implement manual lane changes more easily when the vehicle 210 is traveling in the center of the current road lane 214 as expected, but provides a higher safety threshold when the vehicle 210 is already at an edge of the lane and accidental deactivation of HoLCA could be more dangerous.

As shown in FIG. 2B, the normal threshold 224 may be lowered to a lesser value 226 in response to an impending manual lane change event, such as the driver activating a turn signal or a navigation route requesting a manual lane change. This may facilitate a smoother transition from the HoLCA control to a manual lane change when the vehicle control module is already expecting the manual lane change, as compared to the normal or default override torque thresholds used when a manual lane change is not expected.

In some examples, the override torque threshold may only be lowered in a direction of the expected manual lane change, while leaving the torque threshold at the normal or default value in the opposite direction. For example, if the driver activates a right turn signal, the override torque threshold may be lowered for turning the steering wheel to the right, while the override torque threshold stays the same when turning the steering wheel to the left for safety reasons (e.g., because the vehicle control module is not expecting a manual lane change to the left).

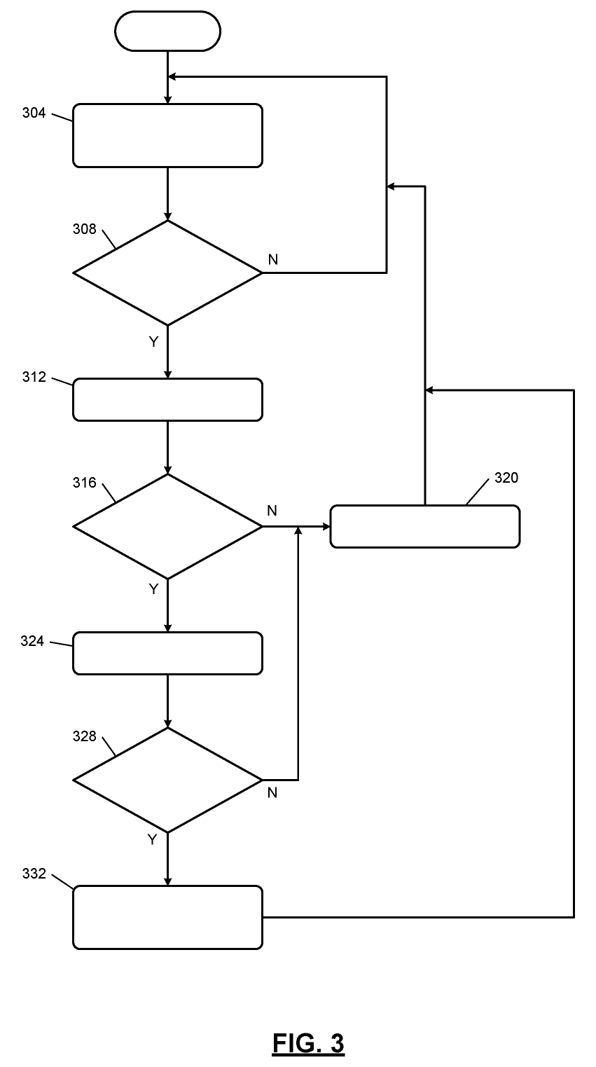

FIG. 3 is a flowchart depicting an example process for adjusting an override threshold in response to a turn signal. The process illustrated in FIG. 3 may be performed by, for example, the vehicle control module 20 of FIG. 1. At 304, the process begins by retrieving a current state of hands-on lane centering assist control.

At 308, the vehicle control module is configured to determine whether the HoLCA control is active. If not, control returns to 304. If the HoLCA control is active at 308, control proceeds to 312 to monitor a status of the turn signal input. If a turn signal input is not active at 316, control proceeds to 320 to maintain the normal or default steering override threshold values.

If the turn signal is active at 316, control proceeds to 324 to determine the presence of any vehicle side zone threats. For example, the vehicle control module may use a rear vehicle camera, side vehicle camera, Lidar, radar, etc., to determine whether another vehicle is sufficiently close to the host vehicle in an adjacent lane that the host vehicle is planning to merge into.

If the side zone of the host vehicle (e.g., an adjacent lane for merging) is not clear of threats at 328, control proceeds to 320 to maintain the normal or default steering override threshold values. If the side zone of the host vehicle is clear of threats at 328, control proceeds to 332 to reduce the steering override torque threshold on the turn signal side by a gain value of K.

For example, the steering override torque threshold may be reduced by at least 0.5 Newton-meters, at least one Newton-meters, at least two Newton-meters, etc. In some examples, a normal or default steering override torque threshold may be at least 2.7 Newton-meters, at least 2.5 Newton-meters, at least two Newton-meters, etc. The reduced steering override torque threshold may be less than two Newton-meters, less than one Newton-meter, less than 0.5 Newton-meters, etc. These values are provided for example only, and various implementations may use any suitable values for torque thresholds and torque threshold reductions.

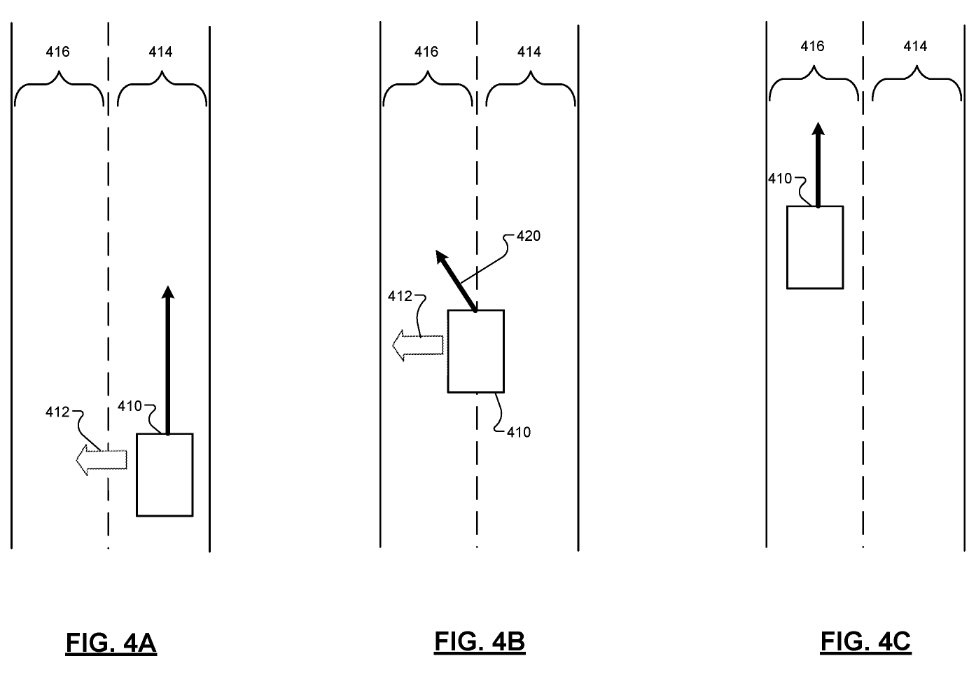

FIGS. 4A-4C are top view diagrams of a vehicle 410 executing a lane change with a reduced torque override threshold in response to a turn signal 412. In the example of FIG. 4A, the vehicle 410 is traveling in a current lane 414 with HoLCA control active.

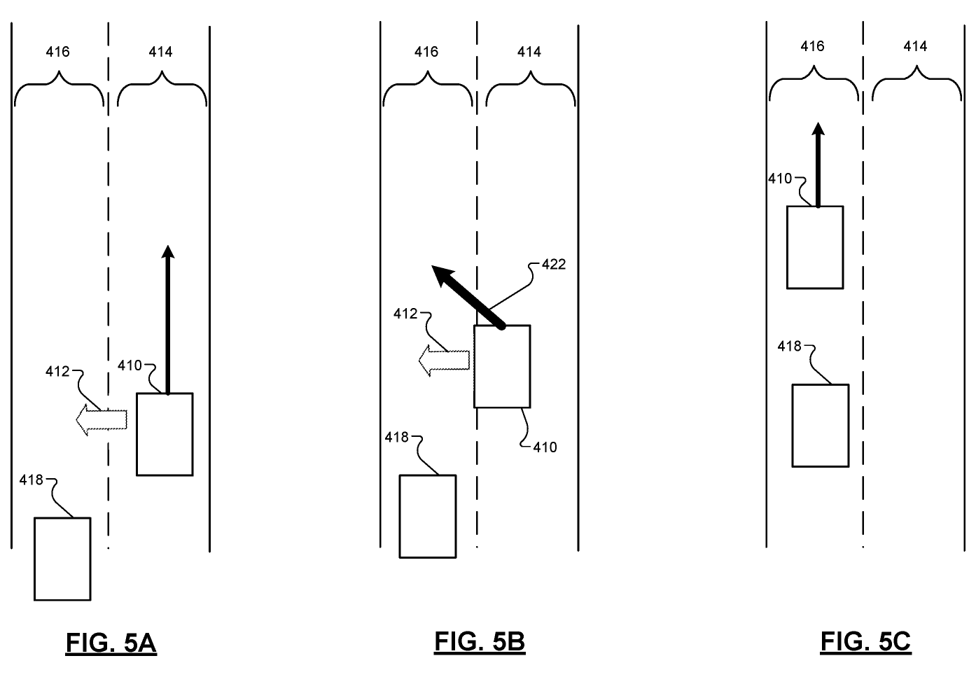

A turn signal 412 is received by the vehicle control module, indicating that the driver plans to manually execute a left lane merge into a target lane 416. The vehicle control module then lowers the steering override torque threshold, and in FIG. 4B the driver deactivates the HoLCA control to execute a manual left lane merge towards the target lane 416 by applying enough steering wheel torque 420 to overcome the reduced steering override torque threshold. In FIG. 5C, the HoLCA control is reactivated, after completion of the manual lane change.

FIGS. 5A-5C are top view diagrams of the vehicle 410 executing a lane change with a detected side threat. In the example of FIG. 5A, the vehicle 410 is traveling in the current lane 414 with HoLCA control active. A turn signal 412 is received by the vehicle control module, indicating that the driver plans to manually execute a left lane merge into a target lane 416.

The vehicle control module detects a side threat 418, which may be another vehicle traveling in the target lane 416 close to the vehicle 410. As shown in FIG. 5B, the vehicle control module does not lower the steering override torque threshold when the side threat 418 is detected, for safety reasons. The driver then has to apply a greater amount of torque 422 to the steering wheel to overcome the normal or default override torque threshold, in order to execute the lane change maneuver manually.

This may prevent or inhibit the driver from accidentally merging into the side threat 418 if the steering override torque threshold were otherwise reduced, because leaving the steering override torque threshold at the normal or default value may prompt the driver to look and make sure they are able to safely execute the manual lane change even with the side threat 418 present. In FIG. 5C, the vehicle control module may reactivate HoLCA control after completion of the manual lane change.

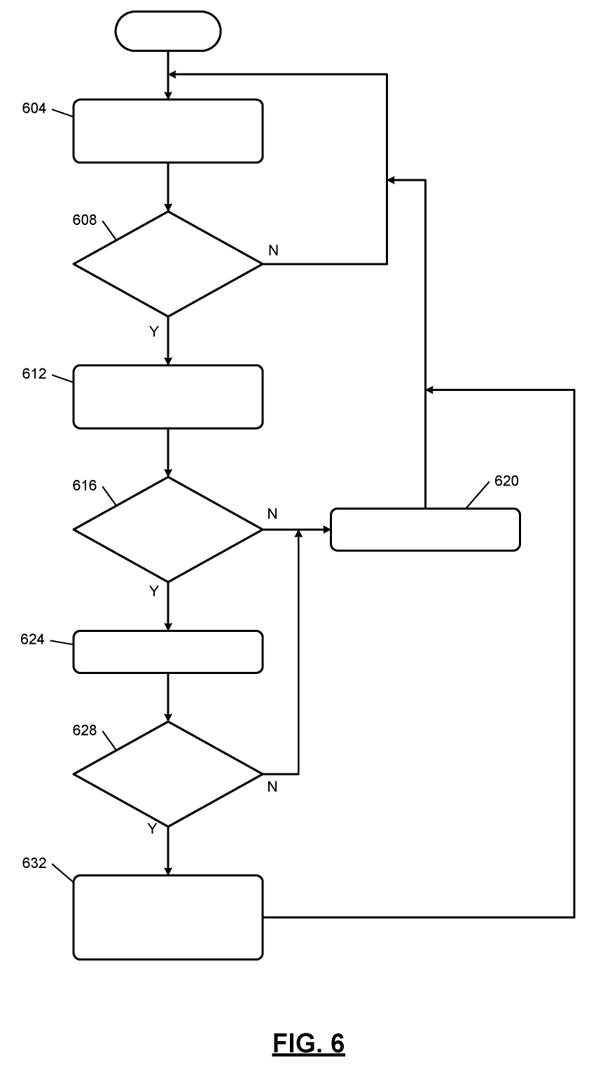

FIG. 6 is a flowchart depicting an example process for adjusting an override threshold in response to a manual lane change request along a navigation route. The process illustrated in FIG. 6 may be performed by, for example, the vehicle control module 20 of FIG. 1. At 604, the process begins by retrieving a current navigation route state, such as a vehicle control module configured to follow automatic route navigation to a specified destination location.

If route navigation is not active at 608, control returns to 604. If the route navigation is active at 608, the vehicle control module is configured to monitor for a manual lane change request along the navigation route. For example, some navigation control systems may request the driver to execute manual lane changes to reach a destination, such as where the vehicle is not equipped to provide automatic steering control for a particular lane change.

At 616, control determines whether a manual lane change has been requested along the navigation route within a specified distance of a current location of the vehicle (e.g., a manual lane change request within half a mile of a current location of the vehicle, within 500 yards, within 500 feet, within 100 feet, etc. If control determines that a manual lane change is not currently requested, control proceeds to 620 to maintain the normal or default steering override threshold values.

If the vehicle control module determines at 616 that a manual lane change has been requested, control proceeds to 624 to determine whether a driver is holding the steering wheel at 624. For example, one or more touch sensors in the steering wheel may be configured to sense whether a driver is currently holding the steering wheel before lowering the override torque thresholds, for safety.

If the vehicle control module determines at 628 that the driver is not currently holding the steering wheel, control proceeds to 620 to maintain the normal or default steering override threshold values. If the driver is holding the steering wheel at 628, control proceeds to 632 to reduce a steering override threshold on the manual lane change request side of the vehicle.

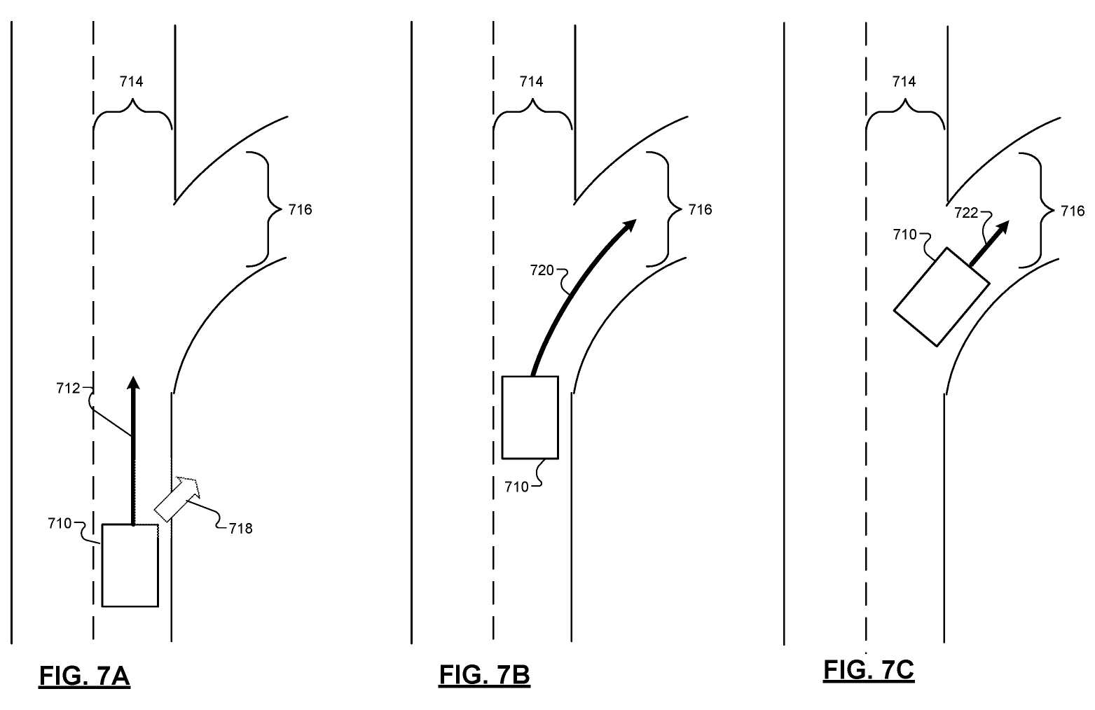

FIGS. 7A-7C are top view diagrams of a vehicle executing a lane change with a reduced torque override threshold in response to a manual lane change request. In the example of FIG. 7A, the vehicle 710 is traveling in a current lane 714 with lane center assist (LCA) control active, and route navigation 712 is active.

A manual lane change request 718 is received by the vehicle control module, indicating that the route navigation is requesting the driver to manually execute a right lane merge into a target lane 716. The vehicle control module then lowers the steering override torque threshold, and in FIG. 7B the driver deactivates the LCA control to execute a manual right lane merge towards the target lane 716 by applying enough steering wheel torque 720 to overcome the reduced steering override torque threshold.

In some examples, the vehicle control module may be configured to reduce the steering override torque threshold more and more as the vehicle 710 approaches the bifurcation point in the road where the manual lane change should take place, such that less torque is required to deactivate the LCA control as the vehicle 710 gets closer to the end of the available road portion for executing the manual lane change (e.g., to make it easier to make the manual turn as the driver gets closer to a point of road separation). In FIG. 7C, the LCA control and route navigation are reactivated, after completion of the manual lane change.

The foregoing description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims. It should be understood that one or more steps within a method may be executed in different order (or concurrently) without altering the principles of the present disclosure. Further, although each of the embodiments is described above as having certain features, any one or more of those features described with respect to any embodiment of the disclosure can be implemented in and/or combined with features of any of the other embodiments, even if that combination is not explicitly described. In other words, the described embodiments are not mutually exclusive, and permutations of one or more embodiments with one another remain within the scope of this disclosure.

Spatial and functional relationships between elements (for example, between modules, circuit elements, semiconductor layers, etc.) are described using various terms, including “connected,” “engaged,” “coupled,” “adjacent,” “next to,” “on top of,” “above,” “below,” and “disposed.” Unless explicitly described as being “direct,” when a relationship between first and second elements is described in the above disclosure, that relationship can be a direct relationship where no other intervening elements are present between the first and second elements, but can also be an indirect relationship where one or more intervening elements are present (either spatially or functionally) between the first and second elements. As used herein, the phrase at least one of A, B, and C should be construed to mean a logical (A OR B OR C), using a non-exclusive logical OR, and should not be construed to mean “at least one of A, at least one of B, and at least one of C.”

In the figures, the direction of an arrow, as indicated by the arrowhead, generally demonstrates the flow of information (such as data or instructions) that is of interest to the illustration. For example, when element A and element B exchange a variety of information but information transmitted from element A to element B is relevant to the illustration, the arrow may point from element A to element B. This unidirectional arrow does not imply that no other information is transmitted from element B to element A. Further, for information sent from element A to element B, element B may send requests for, or receipt acknowledgements of, the information to element A.

In this application, including the definitions below, the term “module” or the term “controller” may be replaced with the term “circuit.” The term “module” may refer to, be part of, or include: an Application Specific Integrated Circuit (ASIC); a digital, analog, or mixed analog/digital discrete circuit; a digital, analog, or mixed analog/digital integrated circuit; a combinational logic circuit; a field programmable gate array (FPGA); a processor circuit (shared, dedicated, or group) that executes code; a memory circuit (shared, dedicated, or group) that stores code executed by the processor circuit; other suitable hardware components that provide the described functionality; or a combination of some or all of the above, such as in a system-on-chip.

The module may include one or more interface circuits. In some examples, the interface circuits may include wired or wireless interfaces that are connected to a local area network (LAN), the Internet, a wide area network (WAN), or combinations thereof. The functionality of any given module of the present disclosure may be distributed among multiple modules that are connected via interface circuits. For example, multiple modules may allow load balancing. In a further example, a server (also known as remote, or cloud) module may accomplish some functionality on behalf of a client module.

The term code, as used above, may include software, firmware, and/or microcode, and may refer to programs, routines, functions, classes, data structures, and/or objects. The term shared processor circuit encompasses a single processor circuit that executes some or all code from multiple modules. The term group processor circuit encompasses a processor circuit that, in combination with additional processor circuits, executes some or all code from one or more modules. References to multiple processor circuits encompass multiple processor circuits on discrete dies, multiple processor circuits on a single die, multiple cores of a single processor circuit, multiple threads of a single processor circuit, or a combination of the above. The term shared memory circuit encompasses a single memory circuit that stores some or all code from multiple modules. The term group memory circuit encompasses a memory circuit that, in combination with additional memories, stores some or all code from one or more modules.

The term memory circuit is a subset of the term computer-readable medium. The term computer-readable medium, as used herein, does not encompass transitory electrical or electromagnetic signals propagating through a medium (such as on a carrier wave); the term computer-readable medium may therefore be considered tangible and non-transitory. Non-limiting examples of a non-transitory, tangible computer-readable medium are nonvolatile memory circuits (such as a flash memory circuit, an erasable programmable read-only memory circuit, or a mask read-only memory circuit), volatile memory circuits (such as a static random access memory circuit or a dynamic random access memory circuit), magnetic storage media (such as an analog or digital magnetic tape or a hard disk drive), and optical storage media (such as a CD, a DVD, or a Blu-ray Disc).

The apparatuses and methods described in this application may be partially or fully implemented by a special purpose computer created by configuring a general purpose computer to execute one or more particular functions embodied in computer programs. The functional blocks, flowchart components, and other elements described above serve as software specifications, which can be translated into the computer programs by the routine work of a skilled technician or programmer.

The computer programs include processor-executable instructions that are stored on at least one non-transitory, tangible computer-readable medium. The computer programs may also include or rely on stored data. The computer programs may encompass a basic input/output system (BIOS) that interacts with hardware of the special purpose computer, device drivers that interact with particular devices of the special purpose computer, one or more operating systems, user applications, background services, background applications, etc.

The computer programs may include: (i) descriptive text to be parsed, such as HTML (hypertext markup language), XML (extensible markup language), or JSON (JavaScript Object Notation) (ii) assembly code, (iii) object code generated from source code by a compiler, (iv) source code for execution by an interpreter, (v) source code for compilation and execution by a just-in-time compiler, etc. As examples only, source code may be written using syntax from languages including C, C++, C#, Objective-C, Swift, Haskell, Go, SQL, R, Lisp, Java®, Fortran, Perl, Pascal, Curl, OCaml, Javascript®, HTML5 (Hypertext Markup Language 5th revision), Ada, ASP (Active Server Pages), PHP (PHP: Hypertext Preprocessor), Scala, Eiffel, Smalltalk, Erlang, Ruby, Flash®, Visual Basic®, Lua, MATLAB, SIMULINK, and Python®.

What is claimed is:

1. A steering control system for a vehicle, the steering control system comprising:
a front vehicle camera configured to capture images including lane boundaries of a road lane of the vehicle;
a steering wheel configured to control a steering orientation of front wheels of the vehicle;
a torque sensor configured to detect a torque value applied to the steering wheel; and
a vehicle control module configured to:
control automatic lane center assist steering of the vehicle according to images captured by the front vehicle camera;
receive a turn signal input;
change a steering torque override threshold from a first value to a second value in response to receiving the turn signal input, where the second value is less than the first value; and
in response to detecting a torque value from the torque sensor greater than the second value, deactivate automatic lane center assist steering to facilitate a manual lane change via steering wheel input.

2. The steering control system of claim 1, wherein the steering torque override threshold is greater at a first position adjacent to one of the lane boundaries than at a second position adjacent a center of the road lane.

3. The steering control system of claim 1, wherein the vehicle control module is configured to:
determine a left direction or a right direction of the turn signal input; and
change the steering torque override threshold from the first value to the second value only in the left direction or the right direction corresponding to the turn signal input.

4. The steering control system of claim 3, further comprising at least one of a side vehicle camera and a rear vehicle camera, wherein the vehicle control module is configured to:
identify another vehicle threat in an adjacent lane in the left direction or the right direction corresponding to the turn signal input, based on one or more images captured by the at least one of the side vehicle camera and the rear vehicle camera; and
maintain the steering torque override threshold at the first value during a period of identifying another vehicle threat in the adjacent lane.

5. The steering control system of claim 1, wherein the second value is at least 0.5 Newton-meters less the first value.

6. The steering control system of claim 5, wherein the second value is less than or equal to two Newton-meters.

7. The steering control system of claim 1, wherein the vehicle control module is configured to:
determine whether a driver is contacting the steering wheel via one or more touch sensors; and
maintain the steering torque override threshold at the first value during a period of identifying that the driver of the vehicle is not contacting the steering wheel.

8. The steering control system of claim 7, wherein the vehicle control module is configured to:
access a navigation route for the vehicle; and
automatically control steering, acceleration and braking of the vehicle to cause the vehicle to follow the navigation route.

9. The steering control system of claim 8, wherein the vehicle control module is configured to:
identify a manual turn request location along the navigation route; and
in response to determining that a distance between a vehicle location and the manual turn request location is less than a manual turn distance threshold, change the steering torque override threshold from the first value to the second value.

10. The steering control system of claim 1, wherein the vehicle control module is configured to receive the turn signal input via movement of a turn signal lever of the vehicle.

11. A steering control system for a vehicle, the steering control system comprising:
a front vehicle camera configured to capture images including lane boundaries of a road lane of the vehicle;
a steering wheel configured to control a steering orientation of front wheels of the vehicle;
a torque sensor configured to detect a torque value applied to the steering wheel; and
a vehicle control module configured to:
access a navigation route for the vehicle;
control automatic lane center assist steering of the vehicle according to images captured by the front vehicle camera, to cause the vehicle to follow the navigation route;
identify a manual turn request location along the navigation route;
in response to determining that a distance between a vehicle location and the manual turn request location is less than a manual turn distance threshold, change a steering torque override threshold from a first value to a second value, where the second value is less than the first value; and
in response to detecting a torque value from the torque sensor greater than the second value, deactivate automatic lane center assist steering to facilitate a manual lane change via steering wheel input.

12. The steering control system of claim 11, wherein the steering torque override threshold is greater at a first position adjacent to one of the lane boundaries than at a second position adjacent a center of the road lane.

13. The steering control system of claim 11, wherein the vehicle control module is configured to:
determine a left direction or a right direction of the manual turn request location; and
change the steering torque override threshold from the first value to the second value only in the left direction or the right direction corresponding to the manual turn request location.

14. The steering control system of claim 13, further comprising at least one of a side vehicle camera and a rear vehicle camera, wherein the vehicle control module is configured to:
identify another vehicle threat in an adjacent lane in the left direction or the right direction corresponding to the manual turn request location, based on one or more images captured by the at least one of the side vehicle camera and the rear vehicle camera; and
maintain the steering torque override threshold at the first value during a period of identifying another vehicle threat in the adjacent lane.

15. The steering control system of claim 11, wherein the second value is at least 0.5 Newton-meters less the first value.

16. The steering control system of claim 15, wherein the second value is less than or equal to two Newton-meters.

17. The steering control system of claim 11, wherein the vehicle control module is configured to:
determine whether a driver is contacting the steering wheel via one or more touch sensors; and
maintain the steering torque override threshold at the first value during a period of identifying that the driver of the vehicle is not contacting the steering wheel.

18. A method of steering control in a vehicle, the method comprising:
controlling, by a vehicle control module, automatic lane center assist steering of a vehicle according to images captured by a front vehicle camera, wherein the front vehicle camera is configured to capture images including lane boundaries of a road lane of the vehicle;
receiving a turn signal input;
changing a steering torque override threshold from a first value to a second value in response to receiving the turn signal input, where the second value is less than the first value;
receiving, from a torque sensor, a torque value applied to a steering wheel of the vehicle; and
in response to the torque value being greater than the second value, deactivating automatic lane center assist steering to facilitate a manual lane change via steering wheel input.

19. The method of claim 18, further comprising:
accessing a navigation route for the vehicle; and
automatically controlling steering, acceleration and braking of the vehicle to cause the vehicle to follow the navigation route.

20. The method of claim 19, further comprising:
identifying a manual turn request location along the navigation route; and
in response to determining that a distance between a vehicle location and the manual turn request location is less than a manual turn distance threshold, changing the steering torque override threshold from the first value to the second value.
